(19) United States
(12) Patent Application Publication
(10) Pub. No.: US 2014/0130285 A1
(43) Pub. Date: May 15, 2014

(54) AIRFOIL FOR WIPER ASSEMBLY

(71) Applicant: TRICO PRODUCTS CORPORATION, Rochester Hills, MI (US)

(72) Inventors: Valentin Avasiloaie, Dearborn Heights, MI (US); Daniel Ehde, Ortonville, MI (US)

(73) Assignee: TRICO PRODUCTS CORPORATION, Rochester Hills, MI (US)

(21) Appl. No.: 13/677,521

(22) Filed: Nov. 15, 2012

(51) Int. Cl. B60S 1/04

(52) U.S. Cl. CPC B60S 1/0408
USPC 15/250.201

(57) ABSTRACT

An airfoil for a wiper assembly includes a body having a top surface, bottom surface, and a front side surface and a rear side surface extending between the top surface and bottom surface. The top surface has a dual angle surface relative to the front side surface and the rear side surface to allow air to flow over the wiper assembly.

### BACKGROUND OF THE INVENTION

1. Field of the Invention

The present invention relates generally to wiper assemblies for vehicles and, mere specifically, to an airfoil for a wiper assembly of a vehicle.

2. Description of the Related Art

Conventional wiper assemblies for vehicles known in the related art include some type of wiper assembly mounted to a wiper arm which, in turn, is mounted adjacent a surface to be wiped such as a windshield of the vehicle and pivotally driven to impart reciprocal motion to the wiper assembly across the windshield. The wiper assembly typically includes a rubber wiping element that contacts the windshield across the surface to be wiped. The wiper assembly often incorporates one or more metal strips which act to reinforce the wiping element and facilitate wiping contact by the wiping element across what is typically a curved glass surface. In this context, the wiper arm delivers a downward force to the wiper assembly that is distributed thereacross pressing the wiper assembly into contact with the windshield. The wiper assemblies may also include an airfoil and a pair of end caps located at the distal ends of the wiper assembly.

Current state of the art wiper strategies require an airfoil to prevent the wiping element from lifting off the surface to be wiped. In some cases, the airfoil has two diverging legs, which are connected to each other by a common base. The free ends of the legs are oriented toward the surface to be wiped and are supported by the wiper blade. The airfoil also has a surface on the outside of the one leg and the relative wind chiefly flows against this surface during operation. The airfoil is typically made of a light weight elastic material.

Currently, for winter driving conditions, snow and ice typically accumulate on the airfoil which is undesired. In addition, due to the light weight material, the airfoil typically requires a surface to contact the wind to hold the wiping element to the surface to be wiped. Further, some conventional wiper assemblies use a rubber boot to cover the entire wiper blade to prevent snow and ice buildup, which boot is undesired. Therefore, there is a need in the art for an effective airfoil to preclude snow and ice buildup on the wiper assembly and prevent wind lift of the wiper assembly during winter driving conditions.

### SUMMARY OF THE INVENTION

The present invention overcomes the disadvantages in the related art in an airfoil for a wiper assembly including a body having a top surface, bottom surface, and a front side surface and a rear side surface extending between the top surface and bottom surface. The top surface has a dual angle surface relative to the frout side surface and the rear side surface to allow air to flow over the wiper assembly.

In addition, the present invention is wiper assembly including a wiping element adapted to contact a surface to be wiped, the wiping element including opposed longitudinal ends. The wiper assembly also includes at least one elongated beam defining a longitudinal axis, the beam acting to support the wiping element and having opposed longitudinal ends. The wiper assembly further includes a pair of end caps operatively mounted to the longitudinal ends of the beam and an airfoil operatively mounted to the beam and extending between the end caps. The airfoil includes a body having a top surface, bottom surface, a front side surface and a rear side surface extending between the top surface and bottom surface. The top surface includes at least two surfaces having an angle relative to each other and the front side surface and the rear side surface to allow air to flow over the wiper assembly.

In this way, the airfoil of the present invention is made of a relatively heavier material and allows the air to flow over the wiper assembly, thereby reducing possible wind lift of the wiping element. In addition, the airfoil of the present invention provides improved air flow over the wiper assembly. The airfoil of the present invention improves performance of wiper blades in the winter weather and wind lift performance. The airfoil of the present invention is used on beam type wiper blades for wind lift performance and snow removal. The materials for the airfoil of the present invention are better at water repellant and good performance in winter weather. Further, the materials for the airfoil are relatively smooth, thereby preventing snow and ice build-up.

Other objects, features and advantages of the present invention will be readily appreciated as the same becomes better understood after reading the subsequent description taken in connection with the accompanying drawings.

### BRIEF DESCRIPTION OF THE DRAWINGS

FIG. 1 is a partial perspective view of a front of a vehicle having a pair of wiper assemblies, according to one embodiment of the present invention, pivotally mounted for reciprocal movement across a windshield of the vehicle.

FIG. 2 is an enlarged perspective view of the wiper assembly according to one embodiment of the present invention.

FIG. 3 is an enlarged perspective view of the wiper assembly according to one embodiment of the present invention removed from a wiper arm.

FIG. 4 is an exploded perspective view of the wiper assembly according to one embodiment of the present invention.

FIG. 5 is cross-sectional view of an airfoil according to one embodiment of the present invention before assembly.

FIG. 6 is a cross-sectional view of the airfoil according to one embodiment of the present invention after assembly.

### DETAILED DESCRIPTION OF THE PREFERRED EMBODIMENT(S)

Referring now to the figures, where like numerals are used to designate like structure, a portion of a vehicle is illustrated at 10 in FIG. 1. The portion of the vehicle 10 includes a body having a cowl 12, a roof 14, and a pair of laterally spaced front or “A” pillars 16 extending between the roof 14 and the cowl 12. The A-pillars 16, roof 14, and cowl 12 cooperate to define a generally rectangular perimeter, which supports a curved or “swept back” windshield 18.

A wiper system is generally shown at 20 in FIG. 1 and is employed to clean the windshield 18. In the representative example illustrated herein, the wiper system 20 includes a pair of wiper assemblies, generally indicated at 22, and which correspond to the driver and passenger side of the vehicle 10. However, those having ordinary skill in the art will appreciate that the wiper system 20 could employ a single wiper assembly 22 without departing from the scope of the present invention. Each wiper assembly 22 is carried by a corresponding wiper arm assembly, generally indicated at 24. The wiper arm assembly 24 includes an attachment member (not shown but generally known in the art) adapted to operatively engage the wiper assembly 22. An electrical motor (not shown but generally known in the art) is typically employed to power the wiper system 20 to move the wiper assemblies 22 in an oscillating manner across the surface of the windshield 18.

While the wiper assembly 22 illustrated in FIG. 1 is shown in connection with the front windshield 18 of the vehicle 10, those having ordinary skill in the art will appreciate that wiper assemblies 22 may be employed in other areas of the vehicle 10, such as a rear window (not shown) or a head lamp (not shown) that employs a wiper system. Thus, it will be understood that the present invention is not limited for use solely in connection with wiper arm assemblies 24 and wiper assemblies 22 adapted for use on a vehicle's windshield 18, but for use in all applications where wiper arm assemblies 24 and wiper assemblies 22 are employed.

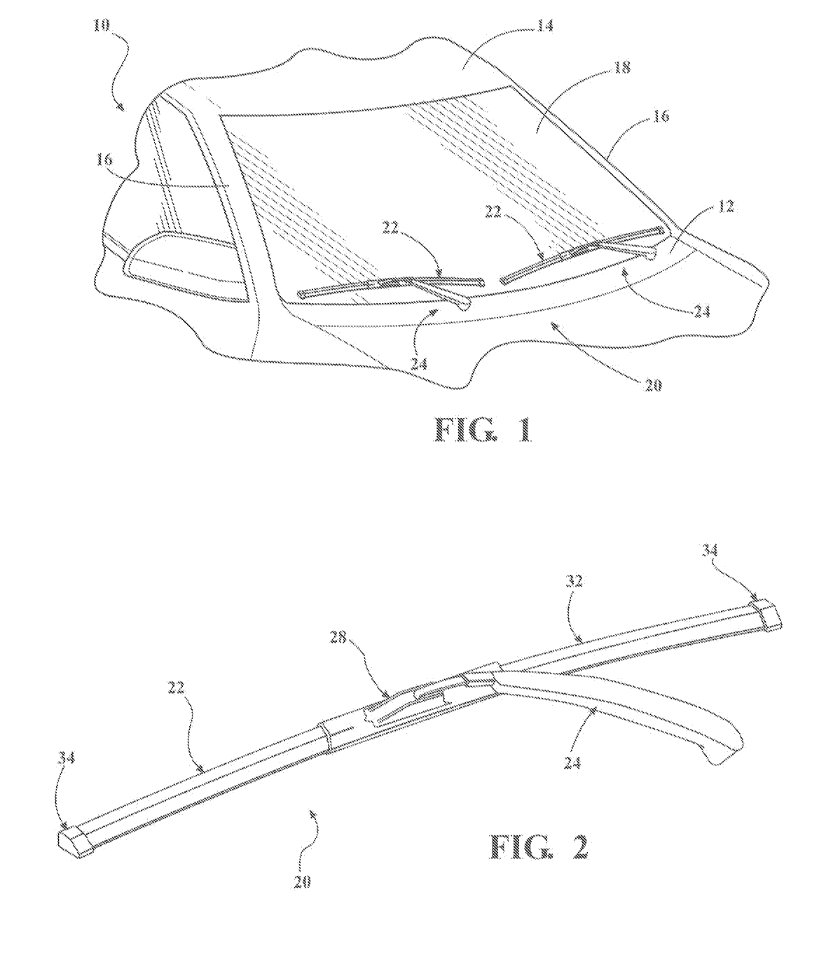

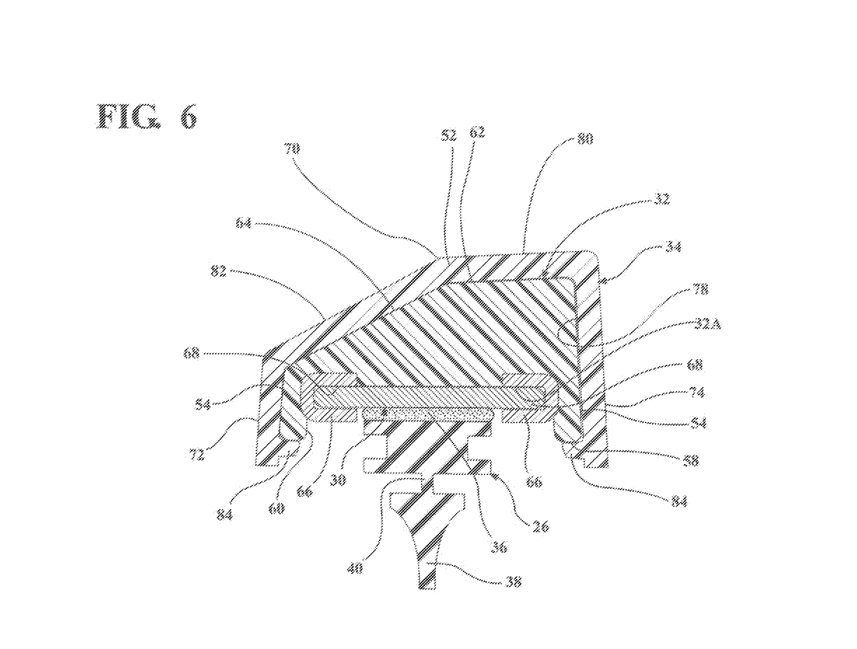

Referring to FIGS. 2 through 6, the wiper assembly 22 includes a wiping element, generally indicated at 26, that is adapted to contact the surface of the vehicle 10 to be wiped, in this representative example, the windshield 18. In addition, the wiper assembly 22 generally includes a coupler assembly, generally indicated at 28, that acts to interconnect the wiper arm assembly 24 and the wiping element 26. The wiper assembly 22 also includes at least one elongated beam, generally indicated at 30, that defines a longitudinal axis and that acts to support the wiping element 26. In the representative embodiment illustrated herein, the beam 30 is generally rectangular in shape and extends longitudinally. The wiping element 26 is attached to a bottom surface of the beam 30 by a suitable mechanism such as an adhesive. However, those having ordinary skill in the art will appreciate from the description that follows that the beam 30 may be either monolithic or defined by a pair of rails. The wiper assembly 22 may also include an airfoil assembly, generally indicated at 32, and a pair of end caps, generally indicated at 34, both according to one embodiment of the present invention. Each of these components will be described in greater detail below.

As best shown in FIGS. 2 through 6, the wiping element 26 includes an upper section 36 and a lower section 38 that are partitioned by a longitudinally extending bridge portion 40. The bridge portion 40 provides flexibility between the upper section 36 and lower section 38 during operational movement of the wiper assembly 22 across the surface to be wiped. The wiping element 26 includes a predetermined length corresponding to particular application and is often manufactured through an extrusion process, which enables the length of the wiping element 26 to be easily adjusted without a substantial increase to manufacturing expense. Furthermore, while the wiping element 26 of the present invention is constructed from a flexible rubber, those having ordinary skill in the art will appreciate that it may be constructed from any flexible material such as silicone or other polymer without departing from the scope of the present invention.

The beam 30 may be constructed from a resiliency flexible material, such as spring steel or a polymer, and is adapted to apply force from an intermediate position between first and second longitudinal ends 42 and 44 to the first and second longitudinal ends 42 and 44. More specifically, the beam 30 receives force from the spring-loaded wiper arm assembly 24 at an intermediate position and distributes this force across the span of the beam 30 toward the first and second longitudinal ends 42 and 44. To that end, the beam 30 may be curved longitudinally with a predetermined radius of curvature. This predetermined radius of curvature is sometimes referred to in the related art as a “free form” radius of curvature. Accordingly, the curvature of the beam 30 may be symmetrical or asymmetrical depending on the force requirements and the contour of the windshield 18. The flexible, free form, pre-curved beam 30 straightens out when the wiper arm assembly 24 applies a force thereto to flatten the beam 30 and directs the wiping element 26 to contact the windshield 18. Thus, the elongated beam 30 includes a free-form curvature that ensures force distribution on windshields having various curvatures that effects proper wrapping about the windshield 18.

As illustrated throughout the figures, the beam 30 has a substantially constant width and may have a constant thickness throughout the length between the first and second longitudinal ends 42 and 44. The constant width and thickness are adapted to provide high lateral and torsional stillness to avoid lateral and torsional deflection, which causes the wiping element 26 to stick/slip (“chatter”) on the windshield 18 during operation. Thus, the cross-section of the beam 30 has a generally rectangular outer profile that makes the elongated beam 30 easier to manufacture. More specifically, where the beam 30 is constructed from metal such as spring steel, the tools and machinery used to manufacture the beam 30 are less complicated than that required to manufacture having varying widths and/or thicknesses, Furthermore, where the beam 30 is constructed from a polymer, such as a thermoplastic elastomer, the tools and extrusion process machinery are also less complicated than those employed to manufacture beams having varying widths and/or thicknesses. However, those having ordinary skill in the art will appreciate that the beam 30 illustrated herein may include a varying thickness and/or width without departing from the scope of the present invention. By way of example, the width and/or thickness of the beam 30 may taper linearly from the beam center, sinusoidally, parabolically, or asymmetrically. Additionally, the beam 30 is illustrated throughout the figures as a single, integral piece of material such that it defines a consolidated cross-section. However, those having ordinary skill in the art will appreciate that the beam 30 may he formed into a single piece by a plurality of laminates.

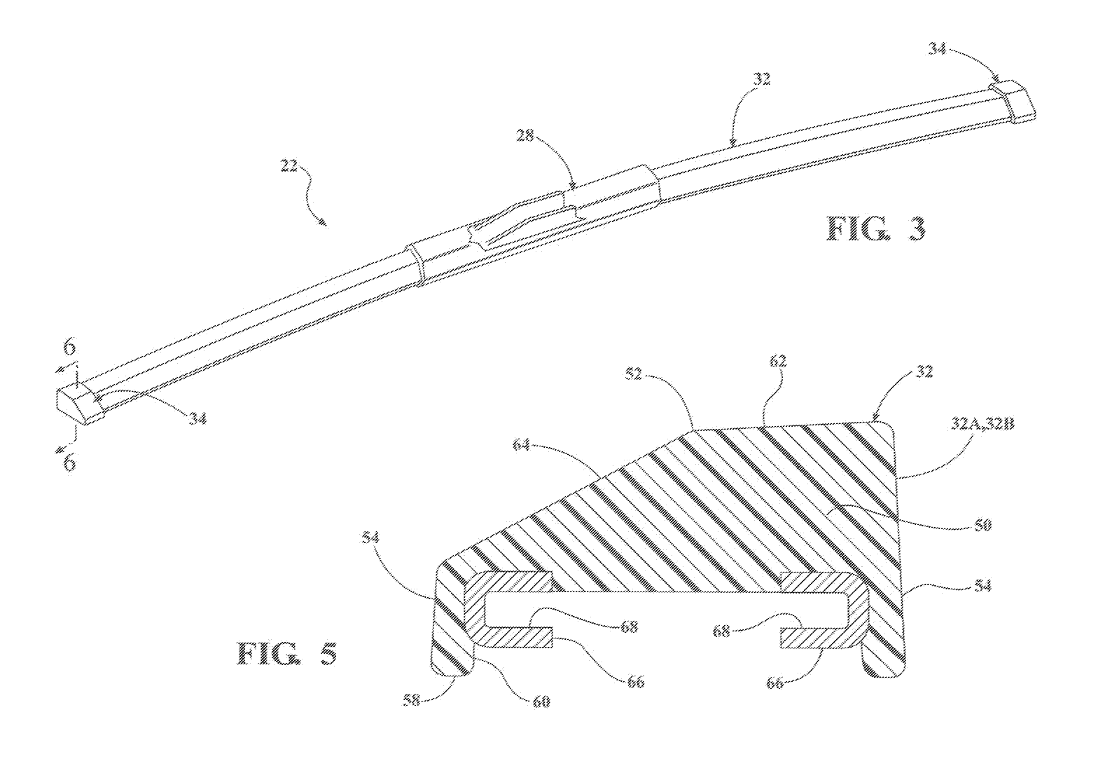

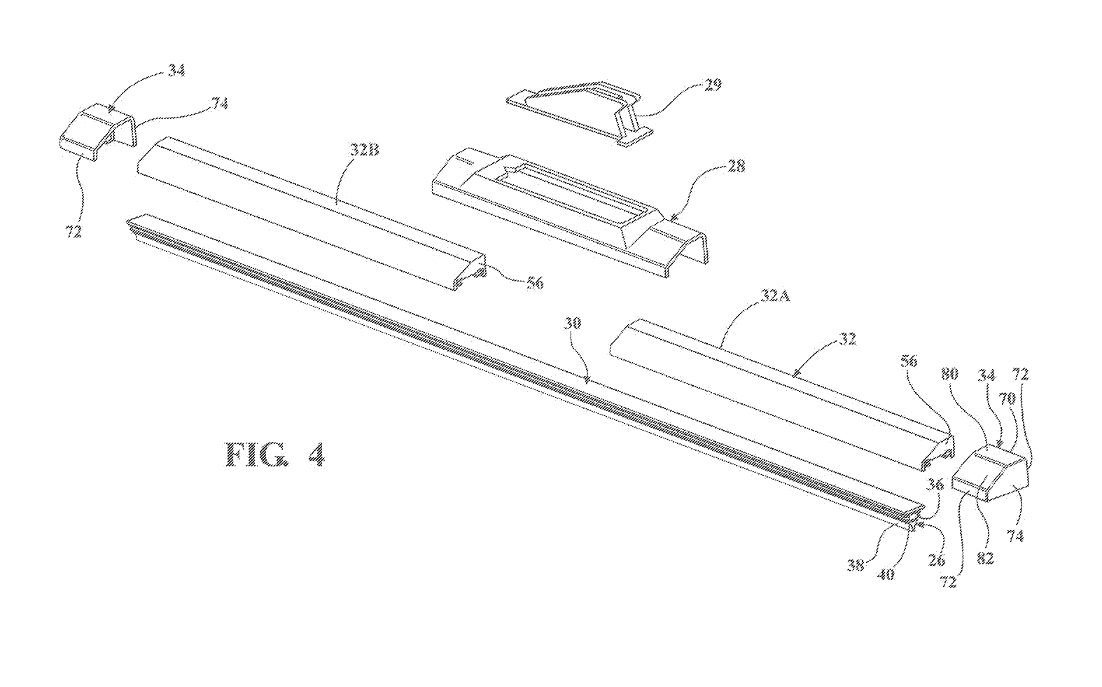

As noted above and as best shown in FIG. 3, the wiper assembly 22 also includes a coupler assembly, generally indicated at 28. The coupler assembly 28 is adapted to connect the wiper assembly 22 to the wiper arm assembly 24. More specifically, those having ordinary skill in the art will appreciate that different OEM's employ wiper arm assemblies having different attachment members adapted to operatively engage a specific wiper assembly. Accordingly, the coupler assembly 28 illustrated herein includes structure that operatively engages at least one or more of these different attachment members. Further by way of example, certain wiper arm assemblies employed by OEM's include “bayonet-style”; “pin-type”; or “hook-type” attachment members of various sizes that operatively engage the wiper assemblies. Accordingly, the coupler assembly 28 illustrated herein may include an adapter 29 (FIG. 4) for operatively engaging at least one or more of these different attachment members for use in connection with the wiper assemblies 22 without departing from the scope of the present invention.

As previously noted, the wiper assembly 22 includes the airfoil, generally indicated at 32 and according to one embodiment of the present invention. The airfoil 32 is operatively mounted to the beam 30. The airfoil 32 extends between each of the pair of end caps 34. The airfoil 32 acts to reduce the likelihood of wind lift by allowing air to flow over the wiper assembly 22. More specifically, and in the embodiment illustrated herein, the airfoil 32 includes a pair of airfoil components 32A, 32B that are operatively mounted to the beam 30 and extend between the coupler 28 and each of the pair of end caps 34. However, those having ordinary skill in the art will appreciate that the airfoil 32 may be defined by a single unitary component without departing from the scope of the present invention.

Referring to FIG. 5, each of the airfoil components 32A, 32B includes a body 50 extending longitudinally. The body 50 has a top surface 52, side surfaces 54, end surfaces 56, and a bottom surface 58. The body 50 also has a recess 60 extending inwardly from the bottom surface 58. The recess 60 extends longitudinally. The recess 60 is generally rectangular in shape. The body 50 is a solid piece made of a material such as plastic. The body 50 is integral, unitary, and one-piece. It should be appreciated that the material is better at water repellant and good performance in winter weather.

In the embodiment illustrated, the top surface 52 has a first surface 62 extending from a rear one of the side surfaces 54 that is orientated at a predetermined angle relative to a horizontal plane such that it extends toward the bottom surface 58 at an angle. The first surface 62 has a predetermined angle of approximately 1 to 10 degrees, preferably 5 degrees. The top surface 52 has a second surface 64 extending between the first surface 62 and a front one of the side surfaces 54 at a predetermined angle relative to the horizontal plane. The second surface 64 has a predetermined angle of approximately 15 to 45 degrees, preferably 28 degrees. The first surface 62 and second surface 64 are generally planar or flat, but may be arcuate in shape without departing from the scope of the invention. It should be appreciated that the top surface 52 has dual angles that improves performance of beam type wiper blades in the winter weather and wind lift performance.

Each of the airfoil components 32A, 32B also includes channel members 66 forming grooves 68 disposed in the recess 60 of the body 50. The channel members 66 are generally “C” shaped in cross-section and extend longitudinally. The channel members 66 are spaced laterally in the recess 60 and secured to the body 50. The channel members 66 may have a durometer harder than a durometer of the body 50 to create a dual durometer airfoil 32. For example, the channel members 66 may have a durometer of 50 Shore O and the body 50 may have a durometer of 67 Shore A. In addition, each of the airfoil components 32A, 32B may be manufactured through an extrusion process. The channel members 66 and body 50 may be manufactured through a dual or co-extrusion process. However, those having ordinary skill in the art will appreciate that the airfoil 32 may be manufactured using any other conventional mechanism.

As noted above, the wiper assembly 22 further includes a pair of end caps, generally indicated at 34 and according to one embodiment of the present invention. The end caps 34 are adapted to be disposed adjacent to the distal ends of the airfoil 32. The end caps 34 are secured to the beam 30 by a suitable mechanism such as press-fitting. The end caps 34 include a profile that substantially mimics the contours of the airfoil 32 to maintain the wind lift characteristics of the wiper assembly 22 and to provide an increased aesthetic value. The end caps 34 also provide a mass increase adjacent the distal ends of the airfoil 32 that prevent localized chatter along the extremities of the wiping element 26 caused by the combination of wind lift and a decrease in the force distributed to this area from wiper arm assembly 24 via the beam 30, as above-described.

The end caps 34 each have a top surface 70, side surfaces 72, end surfaces 74, and a bottom surface 76. The end caps 34 also have a cavity 78 extending longitudinally inwardly from one end surface 74. In the embodiment illustrated, the top surface 70 has a first surface 80 extending from a rear one of the side surfaces 72 that is orientated at a predetermined angle relative to a horizontal plane such that it extends toward the bottom surface 76 at an angle. The first surface 80 has a predetermined angle of approximately 1 to 10 degrees, preferably 5 degrees. The top surface 70 has a second surface 82 extending between the first surface 82 and a front one of the side surfaces 72 at a predetermined angle relative to the horizontal plane. The second surface 82 has a predetermined angle of approximately 15 to 45 degrees, preferably 28 degrees. The first surface 80 and second surface 82 are generally planar or flat, but may be arcuate in shape without departing from the scope of the invention. The end cap 34 also includes a pair of opposed projections 84 extending inwardly from the sides within the cavity 78 to allow the end cap 34 to be press-fit on the beam 30. The end cap 34 is a hollow piece made of a material such as plastic. The end cap 34 is integral, unitary, and one-piece. It should be appreciated that the material is better at water repellant and good performance in winter weather. It also should be appreciated that the top surface 70 has dual angles that improves performance of beam blades in the winter weather and wind lift performance.

The present invention has been described in an illustrative manner. It is to be understood that the terminology which has been used is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. An airfoil for a wiper assembly comprising:
a body having a top surface, bottom surface and a front side surface and a rear side surface extending between the top surface and bottom surface;
said top surface comprising a dual angle surface relative to said front-side surface and said rear side surface to allow air to flow over the wiper assembly.

2. An airfoil as set forth in claim 1 wherein said dual angle surface comprises a first surface at an angle greater than zero degrees (0°) relative to a plane perpendicular to said rear side surface.

3. An airfoil as set forth in claim 2 wherein said angle is approximately fifteen degrees (15°).

4. An airfoil as set forth in claim 2 wherein said dual angle surface comprises a second surface at an angle greater than zero degrees (0°) relative to a plane parallel to said front side surface.

5. An airfoil as set forth in claim 4 wherein said angle is approximately fifteen degrees (15°).

6. An airfoil as set forth in claim 1 wherein said body has a recess extending inwardly from said bottom surface.

7. An airfoil as sot forth in claim 6 including a plurality of channel members spaced laterally and disposed in said recess.

8. An airfoil as set forth in claim 7 wherein said channel members have a durometer harder than a durometer of said body.

9. An airfoil as set forth in claim 1 wherein said body is solid, integral, unitary, and one-piece.

10. An airfoil as set forth in claim 1 wherein said body is made of a plastic material.

11. A wiper assembly comprising:
a wiping element adapted to contact a surface to be wiped, said wiping element including opposed longitudinal ends;
at least one elongated beam defining a longitudinal axis, said beam acting to support said wiping element and having opposed longitudinal ends;
a pair of end caps operatively mounted to said longitudinal ends of said beam;
an airfoil operatively mounted to said beam and extending between said end caps;
said air foil comprising a body having a top surface, bottom surface, a front side surface and a rear side surface extending between the top surface and bottom surface, said top surface comprising at least two surfaces having an angle relative to each other and said front side surface and said rear side surface to allow air to flow over said wiper assembly.

12. A wiper assembly as set forth in claim 11 wherein said at least two surfaces comprises a first surface at an angle greater than zero degrees (0°) relative to a plane perpendicular to said rear side surface and a second surface at an angle greater than zero degrees (0°) relative to a plane parallel to said front side surface.

13. A wiper assembly as set forth in claim 11 wherein said body has a recess extending inwardly from said bottom surface.

14. A wiper assembly as set forth in claim 13 including a plurality of channel members spaced laterally and disposed in said recess.

15. A wiper assembly as set forth in claim 14 wherein said channel members have a durometer harder than a durometer of said body.

16. A wiper assembly as set forth in claim 11 wherein each of said end caps comprising a body having a top surface, bottom surface, a front side surface and a rear side surface extending between the top surface and bottom surface, said top surface comprising at least two surfaces having an angle relative to each other and said front side surface and said rear side surface to allow air to flow over said wiper assembly.

17. A wiper assembly as set forth in claim 16 wherein said at least two surfaces comprises a first surface at an angle greater than zero degrees (0°) relative to a plane perpendicular to said rear side surface and a second surface at an angle greater than zero degrees (0°) relative to a plane parallel to said front side surface.

18. A wiper assembly as set forth in claim 11 wherein said body is solid, integral, unitary, and one-piece.

19. A wiper assembly as set forth in claim 11 wherein said body is made of a plastic material.

20 A wiper assembly for a windshield of a vehicle comprising:
a wiping element adapted to contact a surface to be wiped, said wiping element including opposed longitudinal ends;
at least one elongated beam defining a longitudinal axis, said beam acting to support said wiping element and having opposed longitudinal ends;
a pair of end caps operatively mounted to said longitudinal ends of said beam;
a pair of airfoils operatively mounted to said beam and extending between said end caps;
each of said air foils comprising a body having a top surface, bottom surface, a front side surface and a rear side surface extending between the top surface and bottom surface, said top surface comprising at least two surfaces having an angle relative to each other and said front side surface and said rear side surface to allow air to flow over said wiper assembly; and
each of said end caps comprising a body having a top surface, bottom surface, a front side surface and a rear side surface extending between the top surface and bottom surface, said top surface comprising at least two surfaces having an angle relative to each other and said front side surface and said rear side surface to allow air to flow over said wiper assembly.
